(19) United States
(12) Patent Application Publication
(10) Pub. No.: US 2019/0228663 A1
(43) Pub. Date: Jul. 25, 2019

(54) Taxi Fleet Management Platform Architecture

(71) Applicant: Kaptyn, Inc., Las Vegas, NV (US)

(72) Inventors: Andrew Meyers, Hoboken, NJ (US); James Morgan, Las Vegas, NV (US)

(21) Appl. No.: 15/880,365

(22) Filed: Jan. 25, 2018

(51) Int. Cl. G08G 1/00; G08G 1/13; G06Q 50/30

(52) U.S. Cl. CPC G08G 1/202; G07B 13/06; G06Q 50/30; G08G 1/13

(57) ABSTRACT

A platform architecture system and method for managing a taxi fleet are provided. An example system includes a driver terminal installed in a taxi and configured to collect operational data associated with the taxi. The system includes a data server module for execution on a data server communicatively coupled to the driver terminal, the module configuring the data server to receive, store, and provide authorized access to the driver terminal's operational data. The system includes a customer module, for execution on a computing device communicatively coupled to the data server, which configures the computing device to receive the operational data from the data server, and track, based thereon, a geographical location and occupancy of each taxi. The customer module can receive and aggregate ride requests from various sources and in various forms. Based on the requests and associated geographical location, dispatch request messages are sent to selected taxi driver terminals.

### FIELD

The present application relates generally to transportation services, and, more specifically, to a platform architecture, systems and methods for managing transportation services.

### BACKGROUND

With development of information technology and mobile ride-sharing applications for communication devices, conventional taxi (taxicab) services have been challenged. In contrast to the conventional taxi services, the application-based car services may provide a convenient way to request a ride, a faster car arrival time, and convenient payment options.

Many conventional taxi services still require passengers to call a service dispatch center or make a web reservation ahead of time. It takes time for a service agent to search for available taxis and dispatch the taxi. This may lead to delays with taxi's arrivals, and inefficient dispatch of taxis. For the taxi companies, these inefficiencies can result in additional business expenses and low profitability. However, because of various regulatory requirements, conventional taxi services may provide passengers with a safer ride as compared to the application-based car services.

### SUMMARY

This summary is provided to introduce a selection of concepts in a simplified form that are further described below in the Detailed Description. This summary is neither intended to identify key features or essential features of the claimed subject matter, nor to be used as an aid in determining the scope of the claimed subject matter.

The present disclosure relates to the field of transportation services. Certain embodiments of the present disclosure may include collecting and analyzing operational data of taxis to facilitate dispatching taxis and generating reports concerning productivity and behavior of taxi's drivers. In various embodiments, the system can process and aggregate demand for taxi rides (ride requests) originating from various sources and in various forms.

According to one example embodiment of the present disclosure, a system for managing a fleet of taxis is provided. The system may include at least one driver terminal installed in at least one taxi. The driver terminal may include at least one first processor, first memory-stored processor-executable codes, and a graphical display system. The driver terminal may be configured to collect operational data associated with the at least one taxi. The system may further include at least one data server module for execution on at least one data server communicatively coupled to the driver terminal. The data server module can be for configuring the data server to receive the operational data from the driver terminal. The data server can be further configured, by the data server module, to store and provide authorized access to the operational data.

The system may further include at least one customer module for execution on at least one computing device communicatively coupled to the data server. The computing device may include at least one second processor and second memory-stored processor-executable codes. The at least one customer module can be configuring the computing device to receive the operational data from the data server.

The computing device can be further configured, by the customer module, to track, based on the operational data, at least a geographical location and occupancy of the taxi. The customer module can be for further configuring the computing device to dispatch, based at least on the geographical location and occupancy, the taxi.

In some embodiments, for configuring the computing device to dispatch a taxi, the customer module can be for further configuring the computing device to receive a ride request via at least one of a button device, a mobile application, a web reservation, and a phone call. The ride request can be associated with a further geographical location. The computing device can be further configured, by the customer module, to select, based at least on the further geographical location, a predetermined number of taxis. The customer module can be for further configuring the computing device to send a request message to the driver terminal of the taxi. The request message may include at least the further geographical location.

In certain embodiments, the driver terminal is further configured to, in response to receiving the request message, display, via the graphical display system and for a pre-determined time, a map, the geographical location, the further geographical location, a route from the geographical location to the further geographical location, a travel distance from the geographical location to the further geographical location, a travel time from the geographical location to the further geographical location, and a click button to accept the ride request.

In some embodiments, the customer module can be for further configuring the computing device to analyze the operational data to receive a history of at least one taxi driver. The history may include at least a speeding event, an aggressive acceleration event, and a hard-braking event. The customer module can be for further configuring the computing device to calculate, based on the history, a score of the at least one taxi driver. The computing device can be configured, by the customer module, to estimate, based on the score, at least a coverage rate.

In some embodiments, the customer module can be for further configuring the computing device to generate, based on operational data, a report on productivity of taxi driver. In certain embodiments, the computing device can be further configured, by the customer module, to generate, based on operational data, a trip list of the at least one taxi driver, the trip list being compliant with a regulatory requirement.

According to another example embodiment of the present disclosure, a method for managing a fleet of taxis is provided. The method may include collecting, by at least one driver terminal installed in at least one taxi, operational data associated with the taxi. The driver terminal may include at least one first processor, first memory-stored processor-executable codes, and a graphical display system. The method may further include receiving, by at least one data server module for execution on at least one data server communicatively coupled to the driver terminal, the operational data from the driver terminal. In some embodiments, the method further includes storing and providing, by the data server module, an authorized access to the operational data. The method may include receiving, by at least one customer module for execution on at least one computing device communicatively coupled to the data server, the operational data from the data server. The computing device may include at least one second processor and second memory-stored processor-executable codes. The method may further include tracking, by customer module and based on the operational data, at least a geographical location and occupancy of the taxi. The method may further include dispatching, by the customer module and based at least on the geographical location and the occupancy, the at least one taxi.

According to yet another example embodiment of the present disclosure, the steps of the method of managing a fleet of taxi vehicles are stored on a non-transitory machine-readable medium comprising instructions, which, when implemented by one or more processors, perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements and in which:

FIG. 1A is a block diagram illustrating a system, wherein methods of managing taxi fleet can be practiced, according to some example embodiments.

FIG. 1B is a block diagram illustrating a system, wherein methods of managing taxi fleet can be practiced, according to some further example embodiments.

FIG. 2 shows an example driver terminal, according to an example embodiment.

FIG. 3 shows an example environment, wherein methods of managing taxi fleet can be practiced, according to some example embodiments.

FIG. 4 is a front right angle view of an example card reader, according to an example embodiment.

FIG. 5A is a front left angle view of an example driver terminal, according to various example embodiments.

FIG. 5B shows a position of an example driver terminal in a taxi, according to various example embodiments.

FIG. 6 is a block diagram showing an example system for managing a taxi fleet, according to an example embodiment.

FIG. 7 is a block diagram illustrating functionalities of a dispatch studio, according to an example embodiment.

FIG. 8 shows a screenshot of an example mobile application for requesting a ride, according to an example embodiment.

FIG. 9 is a flow chart showing steps of a method for managing taxi fleet, according to various example embodiments.

FIG. 10 is a flow chart showing steps of a method for managing a taxi fleet, according to some example embodiments.

FIG. 11 is a flow chart showing steps of a method for dispatching taxis, according to various example embodiments.

FIG. 12 is an example computer system that may be used to implement embodiments of the disclosed technology.

### DETAILED DESCRIPTION

The present disclosure provides example methods and systems for managing a taxi fleet. Some embodiments of the present embodiment may facilitate tracking and dispatching taxis. Certain embodiments of the disclosure may allow consolidating of multiple devices required in a taxi into a single universal device performing functions of a regulated taxi meter, a payment processor, and a driver data terminal. Some embodiments of the disclosure may allow real-time collecting and storing taxi data to track taxi drivers' productivity and behavior. Certain embodiments of the disclosure may allow providing real time authorized access to the taxi data for taxi fleet owners, insurers, and regulators. Some embodiments of the disclosure may allow unifying handling ride requests received from different sources, such as, a phone call, a web reservation, a mobile application, and a button device.

According to an example embodiment, a method for managing a taxi fleet may include collecting, by at least one driver terminal installed in at least one taxi, operational data associated with the at least one taxi. The method may further include receiving, by at least one data server module for execution on at least one data server communicatively coupled to the driver terminal, the operational data from the driver terminal. The method may further include storing and providing, by the data server module, an authorized access to the operational data. The method may further include receiving, by at least one customer module for execution on at least one computing device communicatively coupled to the data server, the operational data from the data server. The method may further include tracking, by the customer module and based on the operational data, at least a geographical location and occupancy of the taxi. The method may further include dispatching, by the customer module, the taxi based at least on the geographical location and occupancy.

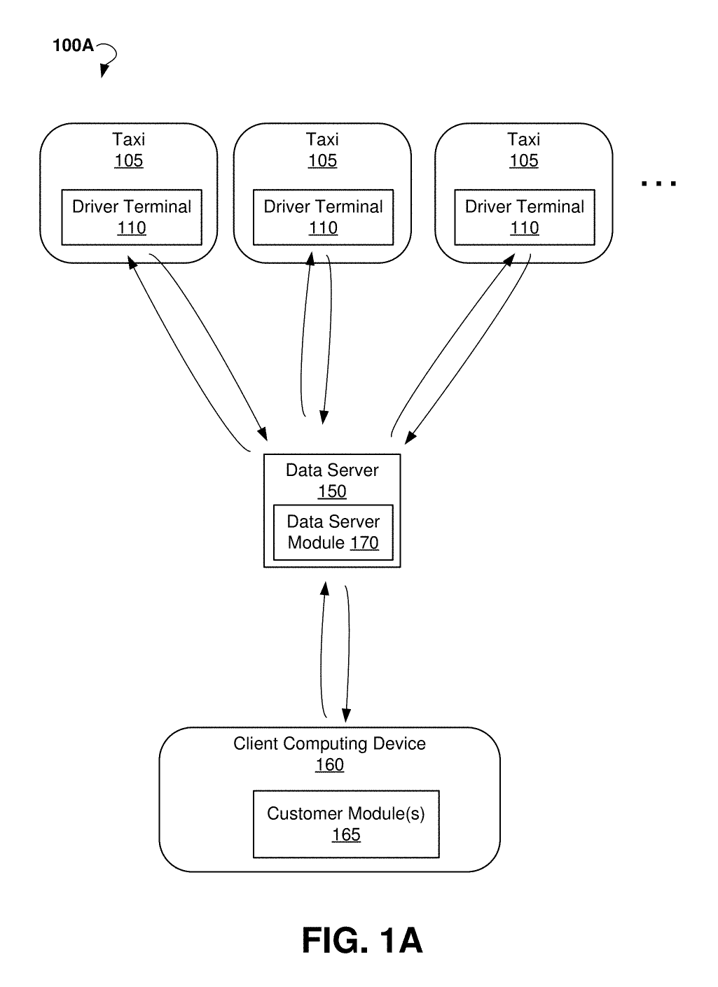

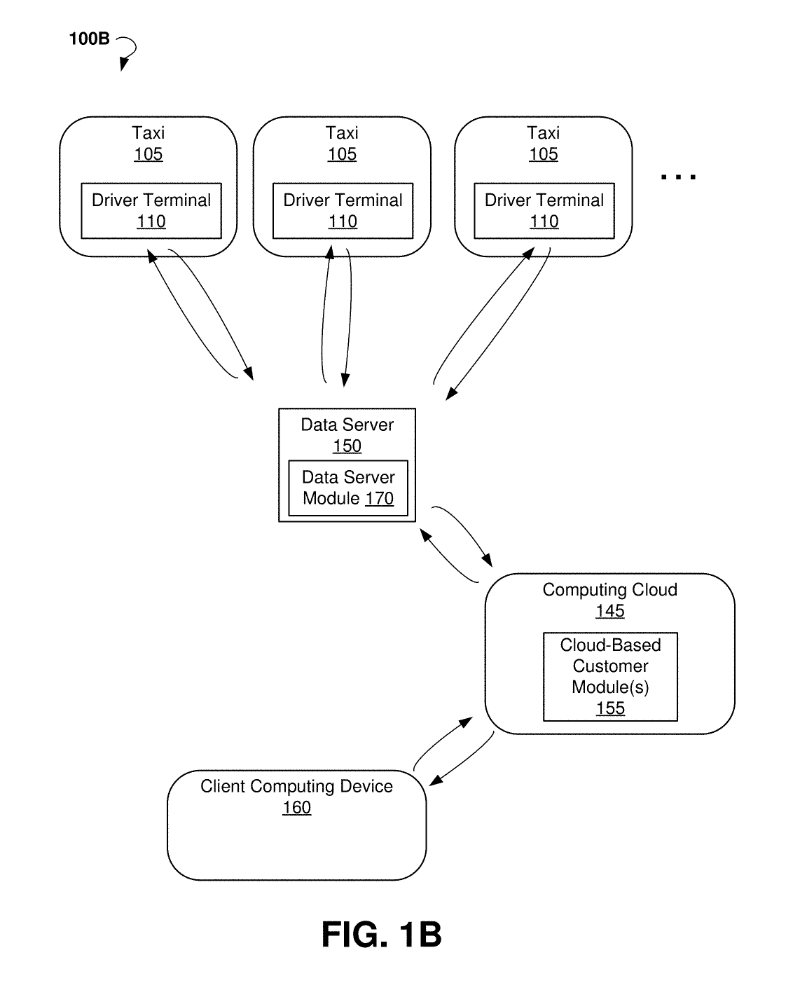

Referring now to FIG. 1A, an example system 100A is shown, wherein methods for managing a taxi fleet can be practiced, according to some example embodiments. The system 100A may include one or more driver terminal(s) 110. The system 100A may further include at least one data server module 170 for execution on at least one data server 150. The driver terminal(s) 110 can be communicatively coupled to the data server 150. The data server 150 may be cloud-based. The system 100A may further include at least one customer module(s) 165 for execution on at least one computing device 160. The computing device 160 can be communicatively coupled to the data server 150.

In some embodiments, the driver terminal(s) 110 may be installed in one or more taxi(s) 105. The driver terminal(s) 110 may be installed on a dashboard of the taxi(s) 105. The driver terminal 110 may be configured to collect and analyze data concerning operation of taxi(s) 105 and performance of drivers of taxi(s) 105. In certain embodiments, the driver terminal 110 may be further configured to send the data to the data server 150 for further processing by the data server module(s) 170.

In some embodiments of the disclosure, the data server module 170 can be configuring the data server 150 to store the data on the driver terminal(s) 110 and to distribute the data from the driver terminal(s) 110 to further devices, for example, to the client computing device 160. In various embodiments, client computing device 160 may include a smartphone, a tablet computer, an all-in-one computer, a laptop computer, a desktop computer, and so forth. In some embodiments, the customer module(s) 165 can be configuring the client computing device 160 for viewing and processing the data received from the driver terminal(s) 110. The data server 150 may be configured, by the data server module 170, to provide the data from the driver terminal(s) 110 to the client computing device 160 and, vice versa, to provide data from the client computing device 160 to the driver terminal(s) 110.

FIG. 1B is a block diagram illustrating an example system 100B, wherein methods for managing a taxi fleet can be practiced, according to some other example embodiments. The example system 100B may include one or more driver terminal(s) 110 installed on taxi(s) 105. The system 100B may further include at least one data server module 170 for execution on at least one data server 150. The driver terminal(s) 110 can be communicatively coupled to the data server 150. The system 100B may further include at least one cloud-based customer module(s) 155 for execution on at least one computing cloud 145.

In some embodiments, the data server 150 may be configured, by the data server module 170, to provide the data from the driver terminal(s) 110 to the client computing cloud 145 for further processing by cloud-based customer module(s) 155. The data server 150 may also be configured, by the data server module 170 to provide data from the computing cloud 145 to the driver terminal(s) 110. In some embodiments, the data server 150 is cloud-based.

In some embodiments, the computing cloud 145 can include computing resources (hardware and software) available at a remote location and accessible over a network (for example, the Internet). The computing cloud 145 can be shared by multiple users and can be dynamically re-allocated based on demand. The computing cloud 145 may include one or more server farms/clusters including a collection of computer servers which can be co-located with network switches and/or routers.

In some embodiments, the cloud-based customer module(s) 155 can be configuring the computing cloud 145 for viewing and analyzing the data from the driver terminal(s) 110.

In some embodiments, a user of the client computing device 160 may access the cloud-based customer module(s) 155, for example, via a web browser.

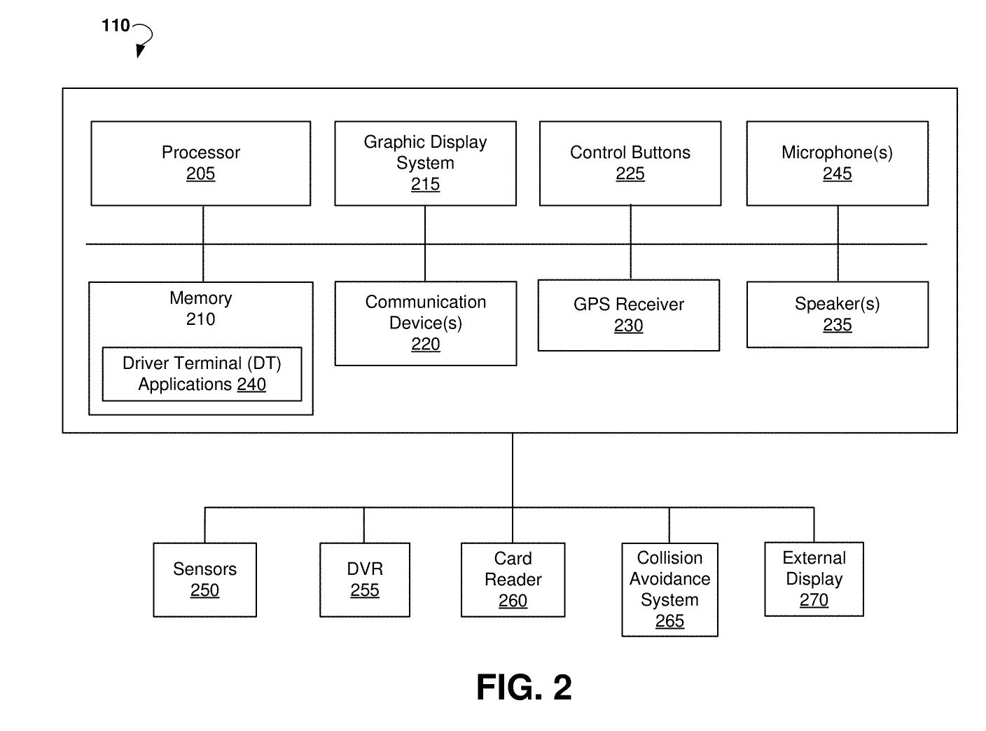

FIG. 2 is a block diagram showing components of a driver terminal 110, according to some example embodiments. The driver terminal 110 may include a processor 205, memory 210, graphical display system 215, communication device(s) 220, control buttons 225, a global positioning system (GPS) receiver 230, speaker(s) 235, and microphone(s) 245. The driver terminal 110 may also include additional or other components necessary for operations of mobile device 110. In other embodiments, the driver terminal 110 can include fewer components that perform similar or equivalent functions to those depicted in FIG. 2.

The processor 205 can include hardware and/or software, which is operable to execute driver terminal (DT) applications 240 stored in the memory 210. The processor 205 can use floating point operations, complex operations, and other operations. In some embodiments, the processor 205, for example, can include at least one of a digital signal processor, an image processor, an audio processor, a general-purpose processor, and the like.

In some embodiments, the graphic display system 215 is configured at least to provide a graphic user interface. In some embodiments, a touch screen can be associated with the graphic display system 215 to receive an input from a driver. Input options (for example, “yes”, “no”, “back”, “forward, “cancel”, and “ok”) can be provided to the driver via an icon or text buttons.

In some embodiments, communication device(s) 220 can include modules operable to communicate data between driver terminal 110 and computing cloud(s) 145 via a network. In various embodiments, the communication device(s) can include a Bluetooth™ module, an infrared module, a Wi-Fi™ module, a near field communication (NFC) module, global system for mobile communications (GSM) module, and the like.

In some embodiments, the control buttons 225 (also known as function buttons) may be associated with functions of driver terminal 110. A driver may press one of the control buttons 225 to turn on and off the driver terminal 110, start or finish specific DT applications 240, adjust brightness of the graphical user system 215 and level of sound of the speaker(s) 235.

In some embodiments, the speaker(s) 235 are configured to play a regular audio signal, for example a music, a speech, and the like. In some embodiments, the microphones 245 can be configured to record voice and speech of a driver of the taxi.

In some embodiments, the GPS receiver 230 is configured to receive data from GPS satellites and determine a geographical location of the taxi on which the driver terminal 110 is installed.

In some embodiments, communication device(s) 220 can include modules operable to communicate data with devices associated with or installed in taxi 105. In some embodiments, the communication device(s) 220 can be configured to receive data from sensors 250, a digital video recorder (DVR) 255, an external payment card reader 260, and a collision avoidance system 265. In certain embodiments, the sensors 250 may include a speedometer and an odometer of the taxi 105. In some embodiments, the communication device(s) 220 may be configured to receive data from a taxi car computer. In some embodiments, the communication device(s) 220 can be configured to provide video data to an external display 270.

In some embodiments, the driver terminal 110 can be configured to send, via communications device(s) 220, the data received from sensors 250, the digital video recorder (DVR) 255, the collision avoidance system 265, and the GPS receiver 230, to computing cloud 145, and further to the data server 150. The data server 150 may be configured to provide the data to the client computing device 160.

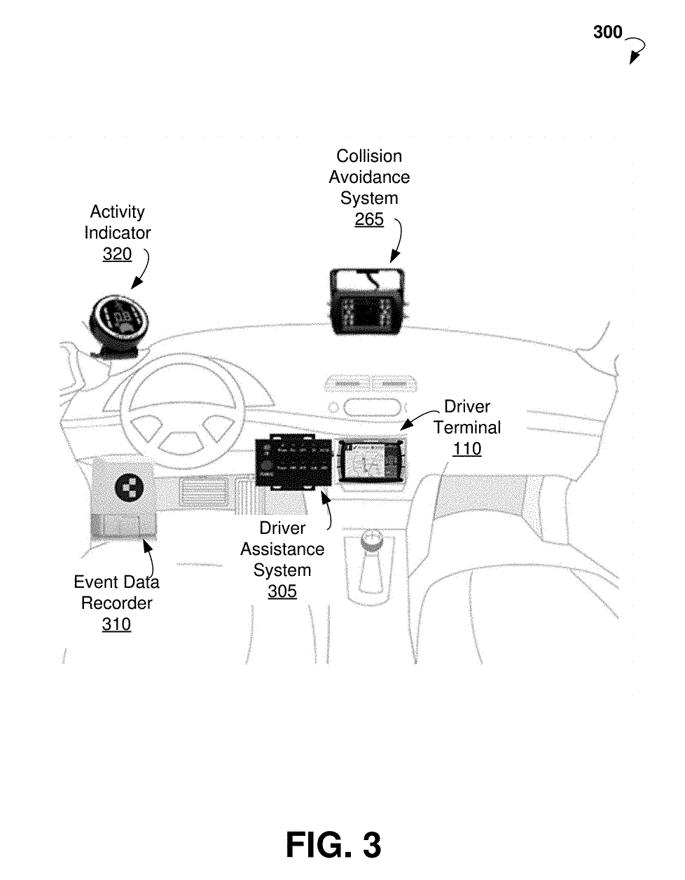

FIG. 3 shows an example environment 300, wherein methods for managing a taxi fleet can be practiced. The environment 300 may include the driver terminal 110, a driver assistance system 305, an event data recorder 310, a collision avoidance system 265, and an activity indicator 320. The driver terminal 110 can be configured to collect data from the driver assistance system 305, the event data recorder 310, the collision avoidance system 225, and the activity indicator 320.

In some embodiments, the collision avoidance assistance system 265 can be configured to detect, based on video sensors and radar sensors, a possible collision with a car (in front or rear) or a pedestrian, and issue a warning to a driver of a taxi within a few seconds of the possible collision.

In some embodiments, the driver assistance system 305 may be configured to determine, based on video and radar sensors, a distance from a taxi to a car ahead and warn the driver if the distance is less than a pre-determined minimum value. In certain embodiments, the driver assistance system 305 may be further configured to determine that the taxi is out of its lane and alarm the driver of the taxi.

In some embodiments, the event data recorder 310 may be configured to record events of aggressive acceleration, hard-braking, and speeding.

In some embodiments, the activity indictor 320 may be configured to measure and display a duration of a ride.

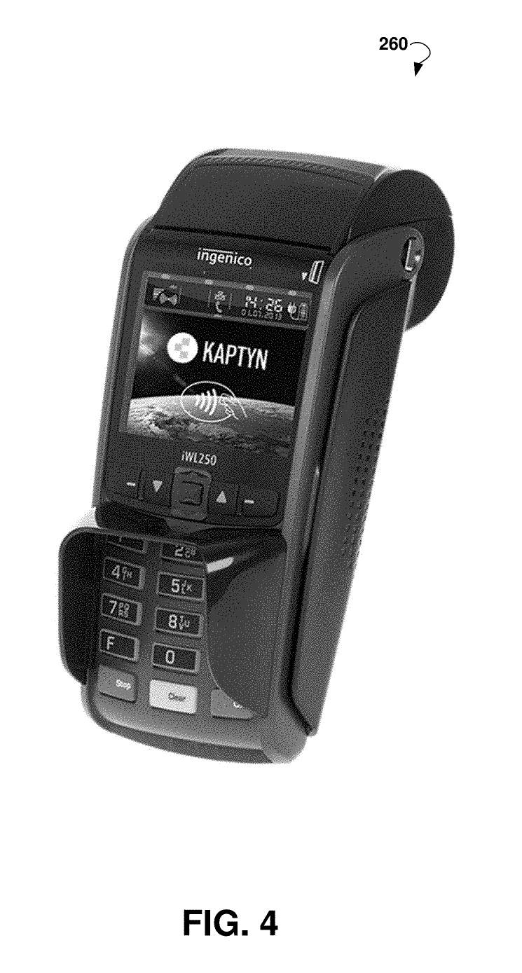

FIG. 4 is a front right angle view of an example card reader 260, according to example embodiments. The card reader 260 can be located at the back seat of a taxi. The card reader 260 may be configured to accept payment information from a passenger and read the payment information from passenger's credit or debit cards. In some embodiments, the card reader 260 can be configured to receive, via a Near Field Communication (NFC), payment information from a contactless card and/or digital wallet (or other mobile payment application) from a mobile device of the passenger.

In some embodiments, the payment information can be sent to the driver terminal 110 for payment processing. In other embodiments, the card reader 260 may include a point of sale (POS) system to process the payment.

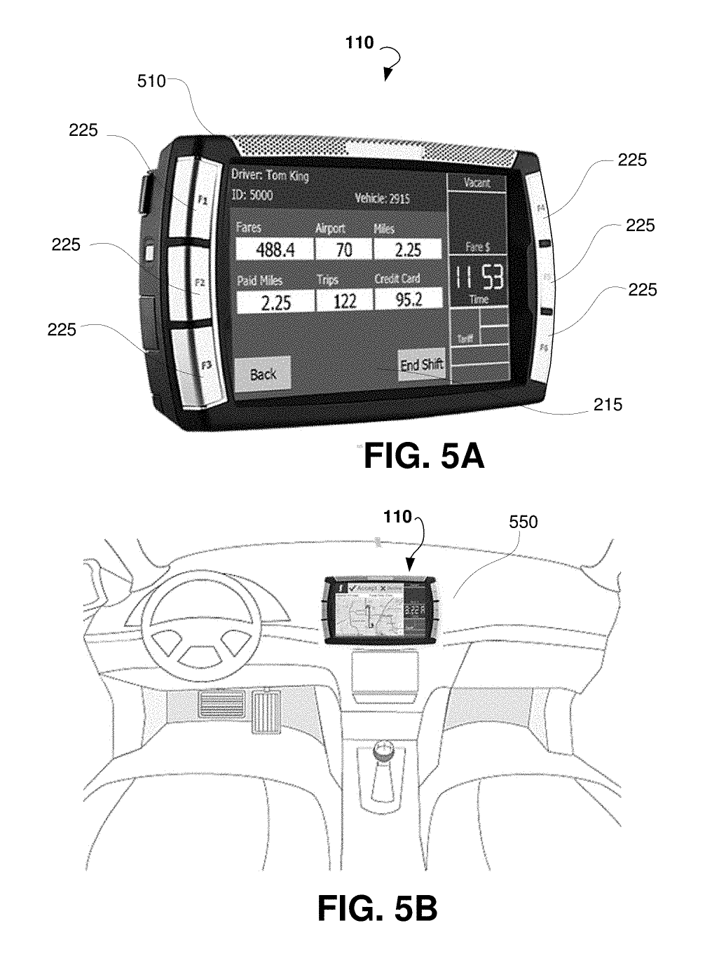

FIG. 5A is a front left angle view of an example driver terminal 110, according to an example embodiment. FIG. 5A shows a body 510, control buttons 225, and a graphical display system 215 of the example driver terminal 110.

FIG. 5B shows an example position of the example driver terminal 110 in a taxi, according to various example embodiment. As shown in FIG. 5B, the driver terminal can be placed in front of a driver seat or in the center of dashboard 550 of a taxi.

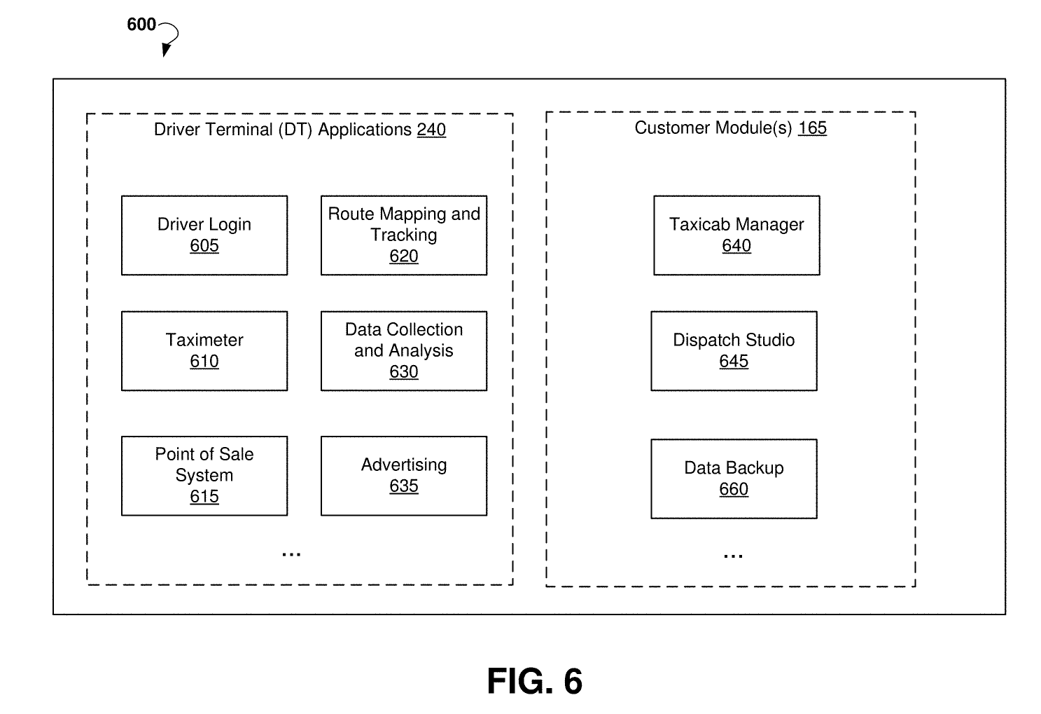

FIG. 6 is a block diagram showing an example system 600 for managing a taxi fleet, according to some example embodiments. The system 600 may include a driver login module 605, a taximeter 610, a POS system 615, a route mapping and tracking module 620, a data collection and analysis module 630, an advertising module 635, a taxicab manger 640, a dispatch studio 645, and a data backup module 660. In some embodiments, the modules 605, 610, 615, 620, and 630 may be implemented as DT applications 240 stored in memory 210 to be executed by processor 205 of the driver terminal 110. In certain embodiments, the modules 640, 645, and 660 can be implemented as customer module(s) 165 (shown in FIG. 1A) stored in a memory of client computing device 160 to be executed by a processor of the client computing device 160. In some other embodiments, the modules 640, 645, and 660 can be implemented as cloud-based customer module(s) 155 (shown in FIG. 1B) to be executed on computing cloud 145.

In some embodiments of the disclosure, the driver login module 605 can be configured to authenticate a driver. The driver may turn on the driver terminal and enter a driver identifier. In some embodiments, the driver identifier and taxi information can be sent to the taxicab manager module 640. The taxicab manager module 640 may be configured to verify, using the driver identifier and the taxi information, whether the driver has authority to drive the taxi, and sent the result of verification to the driver terminal 110. If the result of verification is positive, the driver can receive an authorized access to the rest of applications of the driver terminal 110.

In some embodiments, the taximeter module 610 can be configured to track distance of a ride, time of the ride, and a waiting time. At the end of the ride, the taximeter module 610 can be configured to determine a passenger fare. In some embodiments, the taximeter module 610 may be configured to determine if the ride is to or from an airport and automatically add an airport fee to the passenger fare, if the ride is to or from the airport. In certain embodiments, taximeter can be configured to determine, based on information received from taxicab manager module 640, whether the ride is covered by an insurer (e.g., Medicaid) and adjust the passenger fare accordingly. The taximeter module 610 may be configured to send the passenger fare to the POS system 615.

In some embodiments, the POS system 615 can be configured to receive the passenger fare. The POS system 615 may be further configured to receive payment card information in order to perform payment card transactions. In some embodiments, the payment card information can be obtained via the external payment card receiver 260. In some embodiments, the POS system can be configured to receive, via (NFC), payment information of a digital wallet from a mobile device of the passenger and perform a transaction using the digital wallet of the passenger.

In some embodiments, the route mapping and tracking module 620 may be configured to display, via the graphic display system 215, a map, a start location of a ride, a route of the ride, and an end location of the ride.

The data collection and analysis module 630 can be configured to send operational data to data server 150 in order to be further available to customer module(s) 165 or cloud-based customer module(s) 155. The operational data may include information on rides, for example, the time and start location of the ride and the time and finish location of the ride, a route of the ride, speed and acceleration of the taxi, data from the collision avoidance system 265, and the like. In some embodiments, the data collection and analysis module 630 can be configured to receive video data from DVR 255, process the video data, and send the video data to the data server 150.

In some embodiments, the advertising module 635 can be configured to send a video stream containing advertisement content to an external display 270. In some embodiments, the external display 270 can be located inside the taxi and positioned to be viewed by a passenger. In other embodiments, the external display 270 can be placed on the roof of the car and include two opposite screens. When the taxi rides down a street, the two opposite sides can be configured to be exposed to opposite sides of the street. The advertising module 635 can be configured to send the same video stream or two separate video streams to the two screens. In some embodiments, the video stream(s) can be selected based on a geographical location of the taxi. The geographical location may include a city and a street. The geographical location of the taxi can be determined using GPS data obtained by the GPS receiver 230.

In further embodiments of the disclosure, the applications 165 of the driver terminal 110 may include modules for generating and delivery of detailed electronic receipts to passengers and driver's trip lists compliant with regulatory requirements. The electronic receipts and trip lists can be sent and stored to data server 150.

In some embodiments, the taxicab manager module 640 can be configured to track, based on operational data received from the driver terminal 110, locations and occupancy of the taxi(s) 105. The locations and occupancy of the taxi(s) 105 can be further provided to the dispatch studio 645.

In some embodiments, the module 640 may be configured to collect a driver history. The driver history may include information concerning rides, for example, times of rides, routes of the rides, and speed and acceleration of the taxi during the rides. The driver history may include information concerning events of an aggressive acceleration, hard-braking, speeding, and potential collision accidents.

In some embodiments, the taxicab manager module 640 may be further configured to calculate, based on the driver history, a driver score. The driver score may be used to estimate insurance fees. In certain embodiments, the taxicab manager module 640 may be further configured to generate, based on the history of driver, alarms informative of the driver's behavior. In some embodiments, the taxicab manager module 640 can be configured to generate, based on the driver history, driver productivity reports.

In some embodiments, data backup module 660 can be configured to store operational data, video data received from driver terminal(s) 110, and driver histories generated by the taxicab manager module 640. The operational data and the video data can be stored using duplication and retention techniques. The data back module 660 may be configured to provide an authorized access to the operational data and the video data to authorized persons, for example, representatives of insurers and regulators.

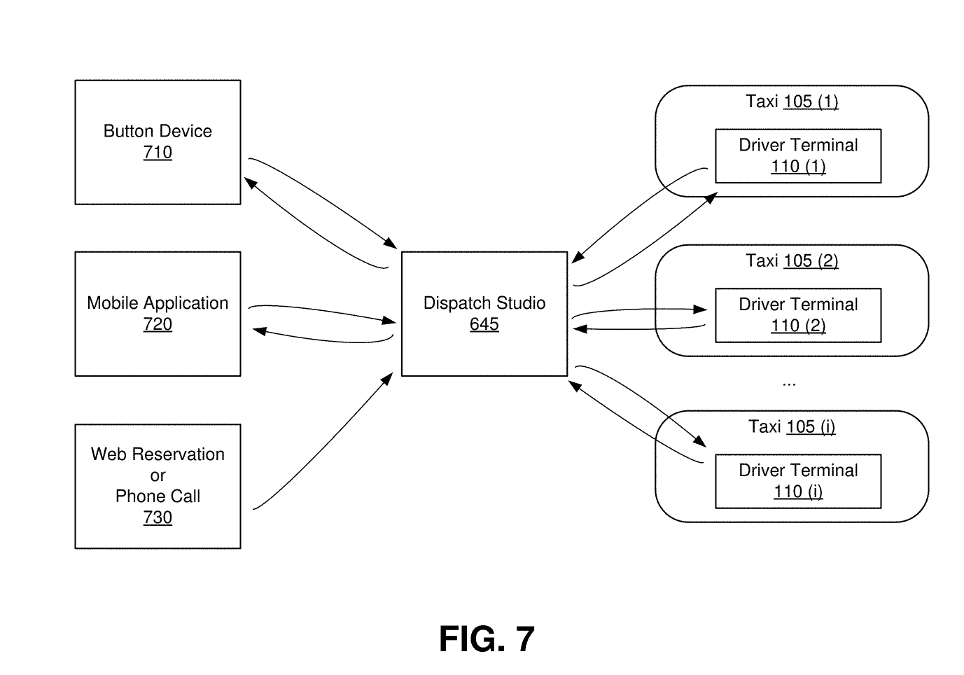

FIG. 7 is a block diagram illustrating functionalities of the dispatch studio 645, according to some example embodiments. In some embodiments, the dispatch studio 645 is configured to receive a request for a ride via several sources: a button device 710, a mobile application 720, a web reservation, or a phone call 730, and other demands.

In some embodiments, the button device 710 may include a body, a button, light-emitting diodes (LEDs), a battery, and communication device(s). The button device 710 can be located at hotels, restaurants, airports, train terminals, and other public places, where frequent requests for taxi rides can be expected. A passenger may request a taxi by pressing the button of the button device 710. In response to the button press, the button device 710 can be configured to send, by communication device(s) and via a network, a message to the dispatch studio 645. The dispatch studio 645 may be configured to determine, based at least on the message from the button device, a geographical location of the button device 710. In some embodiments, the message may include a geographical location of the button device 710. In certain embodiments, the message may include an identifier of the button device and the dispatch studio 645 can be configured to determine geographical location of the button device 710 based on the identifier. After handling the request, the dispatch studio 645 may be configured to send confirmation or rejection to the button device 710. The LEDs of the button device 710 can be configured to blink green light if the request for the ride is confirmed and red light if the request for the ride is rejected.

In some embodiments, the request for a ride can be received by the dispatch studio 645 from the mobile application 720, which may run on a smartphone of a passenger. In some embodiments, the mobile application can be operable to communicate with the dispatch studio 645 via a network.

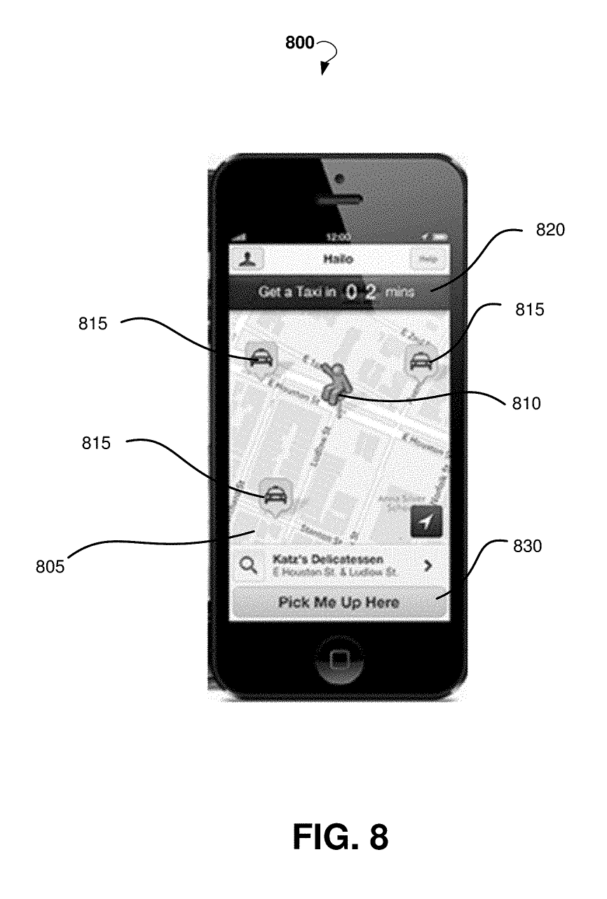

FIG. 8 shows an example screen 800 of the mobile application 720. The screen 800 may include a map 805, a sign 810 showing a location of the passenger, signs 815 showing locations of nearest taxis, a text box 820 showing a distance to the nearest taxis, and a request button 830. The location of the nearest taxis can be provided by the dispatch studio 645. The passenger may request the ride by pressing the request button 830. In response to the pressing of the request button 830, the mobile application 720 can be configured to send a message containing request and geographical location of the passenger to the dispatch studio 645. After handling the request, the dispatch studio 645 may be configured to send a confirmation or a rejection to the mobile application 720.

Referring back to FIG. 7, the dispatch studio 645 can be configured to determine, in response to receiving the request for ride and geographical location, taxi(s) 105 that can be vacant and located near the geographical location of the passenger. In some embodiments, the dispatch studio 645 may be configured to send the request and the geographical location of the request to the driver terminal(s) 110 installed in taxi(s) 105.

In some embodiments, in response to receiving the ride request and the geographical location, the driver terminal(s) 110 may be configured to display, via graphical display system 215, a map, a route from the current geographical location of taxi to the geographical location of the passenger, a distance, and a time of travel to the location of the request. In some embodiments, the driver terminal(s) 110 may be also configured to play, via speaker(s) 235, an alert sound notifying a driver of the ride request. In some embodiments, the driver terminal(s) 110 may be further configured to display a “yes” button for accepting the ride by and a “no” button for rejection of the ride. In some embodiments, the “yes” button can be displayed for a limited pre-determined time, for example 10 seconds. The driver of the taxi may press the “yes” button to accept the ride. Once the driver accepts the ride, the driver terminal(s) 110 may be configured to send confirmation to the dispatch studio 445.

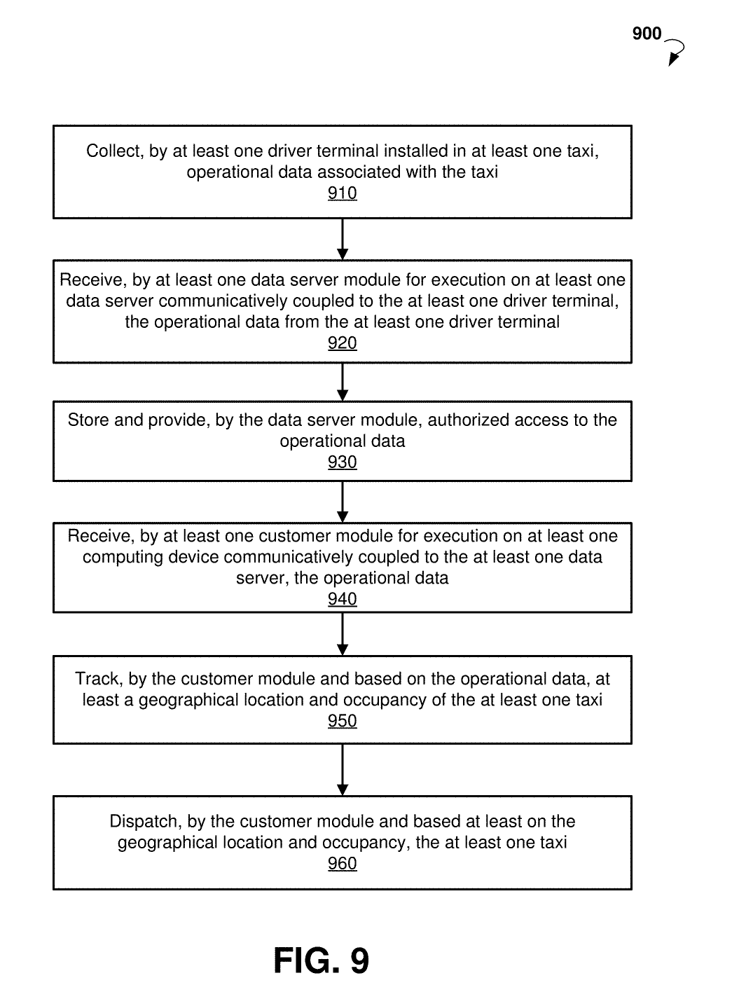

FIG. 9 is a flow chart showing steps of a method 900 for managing a taxi fleet, according to some example embodiments. The method 900 may be performed using components of the system 100A described in FIG. 1A. The method 900 may commence, in block 910, with collecting, by at least one driver terminal 110 installed in at least one taxi 105, operational data associated with the at least one taxi 105. The operational data may include a route of at least one ride, a time of the ride, speed data during the at least one ride, acceleration data during the at least one ride, video data recorded by a mobile digital video recorder during the at least one ride.

In block 920, the method 900 may include receiving, by at least one data server module 170 for execution on at least one data server 150, the operational data from the at least one driver terminal 110. In block 930, the method 900 may include storing and providing, by the data server module 170, an authorized access to the operational data. In block 940, the method 900 may include receiving, by at least one customer module 165 for execution on the client computing device 160, the operational data from the at least one data server 150. In block 950, the method 900 may include tracking, by the customer module 165 and based on the operational data, at least a geographical location and an occupancy of the at least one taxi 105. In block 960, the method 900 may include dispatching, by the customer module 165 and based at least on the geographical location and the occupancy, the at least one taxi 105.

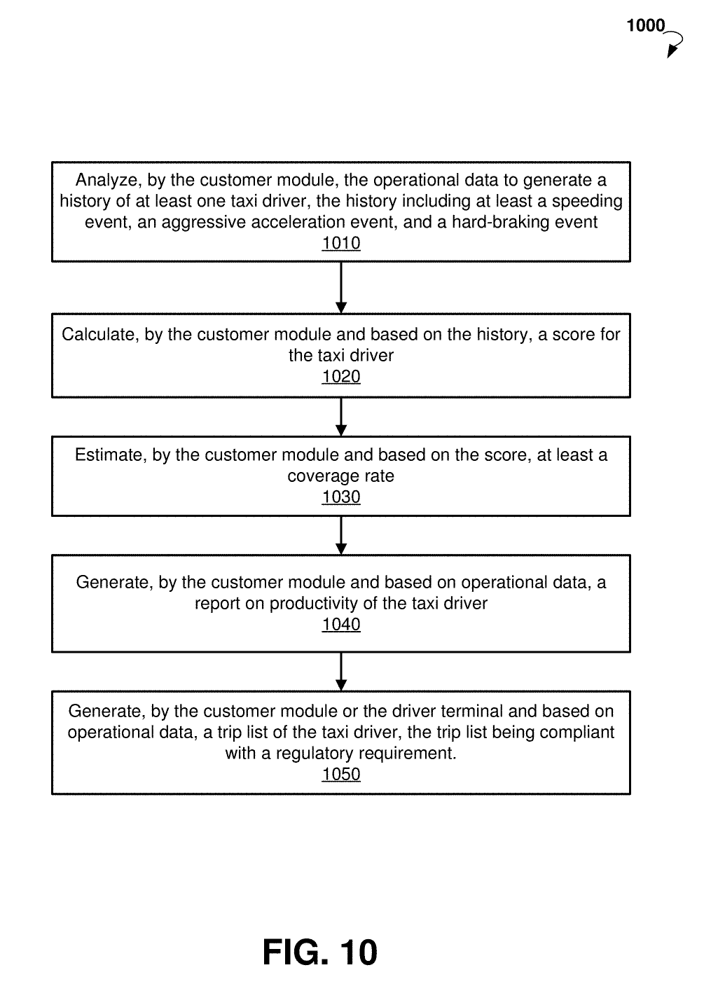

FIG. 10 is a flow chart showing steps of a method 1000 for managing a taxi fleet, according to some other example embodiments. The method 8100 may be performed using components of the system 100A described in FIG. 1A. The method 1000 may provide additional steps to the method 900 described above with reference to FIG. 9.

In block 1010, the method 1000 may include analyzing, by the customer module 165 for execution on client computing device 160, the operational data to receive a history of at least one taxi driver. The history may include speeding events, aggressive acceleration events, hard-braking events, events recorded by collision avoidance system, and so forth. In block 1020, the method 1000 may include calculating, by the customer module 165 and based on the history, a score of the taxi driver. In block 1030, the method 1000 may include estimating, by the customer module 165 and based on the score, at least an insurance coverage rate. In block 1040, the method 1000 may include generating, by the customer module 165 and based on the operational data, a report on productivity of the taxi driver. In block 1050, the method 1000 may include generating, by either the customer module 165 or the driver terminal 110, a trip list of the taxi driver. The trip list can be compliant with a regulatory requirement.

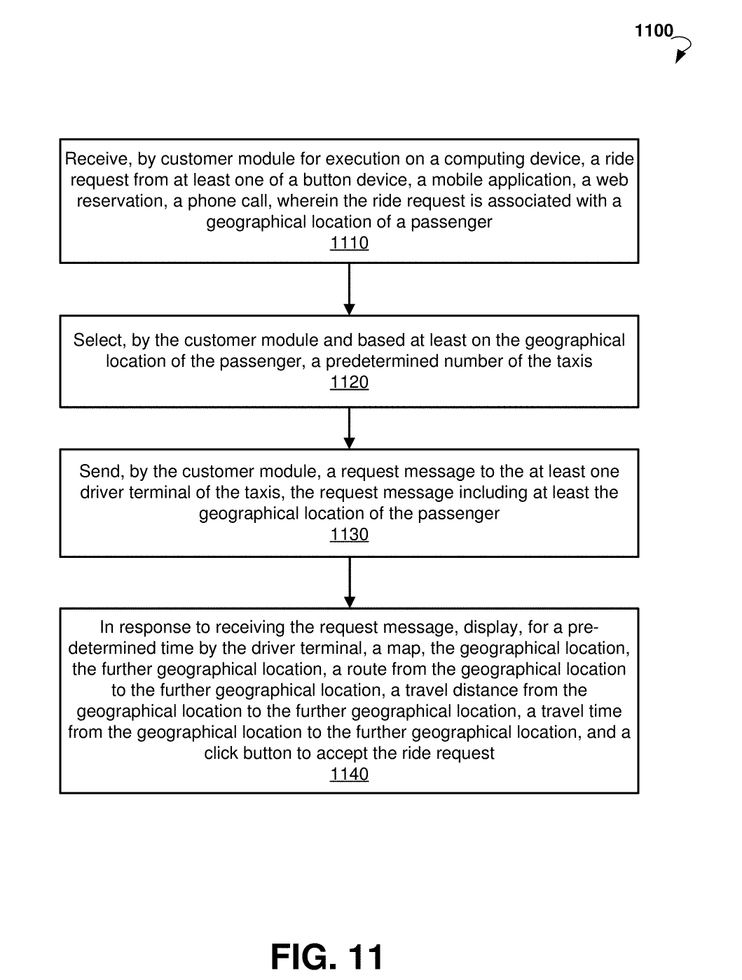

FIG. 11 is a flow chart showing steps of a method 1100 for dispatching taxis, according to some example embodiments. The method 1100 may be performed using components of the system 100A described in FIG. 1A. The method 1100 may provide additional details for step 960 of the method 900 described above with reference to FIG. 9.

In block 1110, the method 1100 may commence with receiving, by the customer module 165, a ride request. The ride request can be received via the button device 710, a mobile application 720, a web reservation, and a phone call. The ride request may include a geographical location of a passenger.

In block 1120, the method 1100 may include selecting, by the customer module 165 and based at least on the geographical location of the passenger, a predetermined number of the taxis 105. In block 1130, the method 1100 may include sending, by the customer module, a request message to the driver terminal(s) 110 of the taxi(s) 105. The request message may include the geographical location of the passenger. In block 1140, the method 1100 may include, in response to receiving the request message, displaying for a pre-determined time, by the driver terminal(s) 110, a map, the geographical location of taxi, the geographical location of the passenger, a route from the geographical location to the geographical location of a passenger, a travel distance and time for travel from the geographical location of taxi to the geographical location passenger, and a click button to accept the ride request.

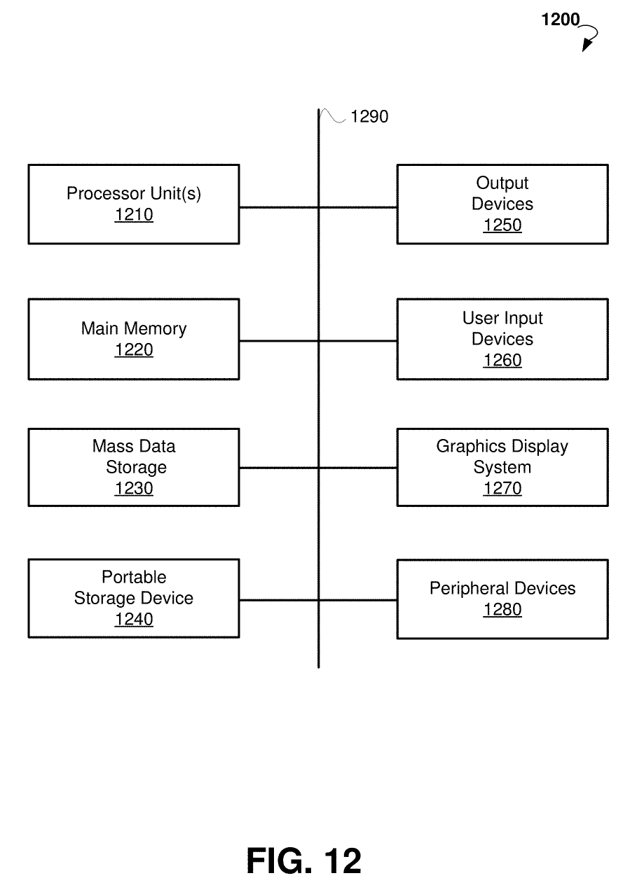

FIG. 12 illustrates an exemplary computer system 1200 that may be used to implement some embodiments of the present invention. The computer system 1200 of FIG. 12 may be implemented in the contexts of the likes of computing systems, networks, servers, or combinations thereof. The computer system 1200 of FIG. 12 includes one or more processor units 1010 and main memory 1220. Main memory 1220 stores, in part, instructions and data for execution by processor units 1210. Main memory 1220 stores the executable code when in operation, in this example. The computer system 1200 of FIG. 12 further includes a mass data storage 1230, portable storage device 1240, output devices 1250, user input devices 1260, a graphics display system 1270, and peripheral devices 1280.

The components shown in FIG. 12 are depicted as being connected via a single bus 1290. The components may be connected through one or more data transport means. Processor unit 1210 and main memory 1220 is connected via a local microprocessor bus, and the mass data storage 1230, peripheral device(s) 1280, portable storage device 1240, and graphics display system 1270 are connected via one or more input/output (I/O) buses.

Mass data storage 1230, which can be implemented with a magnetic disk drive, solid state drive, or an optical disk drive, is a non-volatile storage device for storing data and instructions for use by processor unit 1210. Mass data storage 1230 stores the system software for implementing embodiments of the present disclosure for purposes of loading that software into main memory 1220.

Portable storage device 1240 operates in conjunction with a portable non-volatile storage medium, such as a flash drive, floppy disk, compact disk, digital video disc, or Universal Serial Bus (USB) storage device, to input and output data and code to and from the computer system 1200 of FIG. 12. The system software for implementing embodiments of the present disclosure is stored on such a portable medium and input to the computer system 1200 via the portable storage device 1240.

User input devices 1260 can provide a portion of a user interface. User input devices 1260 may include one or more microphones, an alphanumeric keypad, such as a keyboard, for inputting alphanumeric and other information, or a pointing device, such as a mouse, a trackball, stylus, or cursor direction keys. User input devices 1260 can also include a touchscreen. Additionally, the computer system 1200 as shown in FIG. 12 includes output devices 1250. Suitable output devices 1250 include speakers, printers, network interfaces, and monitors.

Graphics display system 1270 include a liquid crystal display (LCD) or other suitable display device. Graphics display system 1270 is configurable to receive textual and graphical information and processes the information for output to the display device.

Peripheral devices 1280 may include any type of computer support device to add additional functionality to the computer system.

The components provided in the computer system 1200 of FIG. 12 are those typically found in computer systems that may be suitable for use with embodiments of the present disclosure and are intended to represent a broad category of such computer components that are well known in the art. Thus, the computer system 1200 of FIG. 12 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 1200 is implemented as a cloud-based computing environment, such as a virtual machine operating within a computing cloud. In other embodiments, the computer system 1200 may itself include a cloud-based computing environment, where the functionalities of the computer system 1200 are executed in a distributed fashion. Thus, the computer system 1200, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computer system 1200, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A system for managing a taxi fleet, the system comprising:
at least one driver terminal installed in at least one taxi, the at least one driver terminal comprising at least one first processor, first memory-stored processor-executable codes, and a graphical display system, the at least one driver terminal configured to collect operational data associated with the at least one taxi;
at least one data server module for execution on a data server communicatively coupled to the at least one driver terminal, the at least one data server module for configuring the data server to:
receive the operational data from the at least one driver terminal;
store and provide an authorized access to the operational data; and
at least one customer module for execution on a computing device communicatively coupled to the at least one data server, the at least one computing device comprising at least one second processor and second memory-stored processor-executable codes of the at least one customer module, the at least one customer module for configuring the computing device to:
receive the operational data from the at least one data server;
track, based on the operational data, at least a geographical location and occupancy of the at least one taxi; and
dispatch, based at least on the geographical location and occupancy, the at least one taxi.

2. The system of claim 1, wherein, for configuring the at least one computing device to dispatch the at least one taxi, the at least one customer module is further for configuring the at least one computing device to:
receive a ride request from a button device, a mobile application, a web reservation, or a phone call, the ride request being associated with a further geographical location;
select, based at least on the further geographical location, a predetermined number of the at least one taxi; and
send a request message to the at least one driver terminal of the at least one taxi, the request message including at least the further geographical location.

3. The system of claim 2, wherein the at least one driver terminal is further configured to:
in response to receiving the request message, display, via the graphical display system and for a pre-determined time, a map, the geographical location, the further geographical location, a route from the geographical location to the further geographical location, a travel distance from the geographical location to the further geographical location, travel time from the geographical location to the further geographical location, and a click button to accept the ride request.

4. The system of claim 1, wherein the at least one driver terminal is further configured to:
calculate, based on the operational data, a passenger fare;
receive payment information from a passenger; and
perform, based on the payment information and the passenger fare, a payment transaction.

5. The system of claim 1, wherein the operational data include a route of at least one ride, time of the at least one ride, speed data during the at least one ride, and acceleration data during the at least one ride.

6. The system of claim 5, wherein, based on the operational data, a manager or owner of the taxi fleet may receive a refund or credit as a function of operational data indicating safe operation of the at least one taxi.

7. The system of claim 1, further comprising a mobile digital video recorder installed in the at least one taxi, the mobile digital video recorder communicatively coupled to the at least one driver terminal and wherein the operational data include video data recorded by the mobile digital video recorder during at least one ride.

8. The system of claim 1, further comprising at least one external display communicatively coupled to the at least one driver terminal, and wherein the at least one driver terminal is further configured to display, via the at least one external display, a video content, the video content being selected based on the geographical location.

9. The system of claim 1, wherein the at least one customer module is further for configuring the at least one computing device to:
analyze the operational data to receive a history of at least one taxi driver, the history including at least a speeding event, an aggressive acceleration event, and a hard-braking event;
calculate, based on the history, a score of the at least one taxi driver; and
estimate, based on the score, at least a coverage rate.

10. The system of claim 1, wherein the at least one consumer module is further for configuring the at least one computing device to generate, based on operational data, a report concerning productivity of at least one taxi driver and a trip list of the at least one taxi driver, the trip list being compliant with a regulatory requirement.

11. A method for managing a taxi fleet, the method comprising:
collecting, by at least one driver terminal installed in at least one taxi, operational data associated with the at least one taxi, wherein the at least one driver terminal includes at least one first processor, first memory-stored processor-executable codes, and a graphical display system;
receiving, by at least one data server module for execution on at least one data server communicatively coupled to the at least one driver terminal, the operational data from the at least one driver terminal;
storing and providing, by the at least one data server module, an authorized access to the operational data;
receiving, by at least one customer module for execution on at least one computing device communicatively coupled to the at least one data server, the operational data from the at least one data server, wherein the at least one computing device includes at least one second processor and second memory-stored processor-executable codes;
tracking, by at least one customer module and based on the operational data, at least a geographical location and an occupancy of the at least one taxi; and
dispatching, by the at least one customer module and based at least on the geographical location and the occupancy, the at least one taxi.

12. The method of claim 11, wherein the dispatching includes:
receiving, by the at least one customer module, a ride request from a button device, a mobile application, a web reservation, or a phone call, wherein the ride request is associated with a further geographical location;
selecting, by the at least one customer module and based at least on the further geographical location, a predetermined number of the at least one taxi; and
sending, by the at least one customer module, a request message to the at least one driver terminal of the at least one taxi, the request message including at least the further geographical location.

13. The method of claim 12, further comprising:
in response to receiving the request message, displaying for a pre-determined time, by the at least one terminal device and via the graphical display system, a map, the geographical location, the further geographical location, a route from the geographical location to the further geographical location, a travel distance from the geographical location to the further geographical location, a travel time from the geographical location to the further geographical location, and a click button to accept the ride request.

14. The method of claim 11, further comprising:
calculating, by the at least one driver terminal and based on the operational data, a passenger fare;
adjusting, by the at least one driver terminal and based on the operational data, the passenger fare to further include at least an airport fare;
receiving, by the at least one driver terminal, payment information from a passenger; and
performing, by the at least one driver terminal and based on the payment information and the passenger fare, a payment transaction.

15. The method of claim 11, wherein the operational data include a route of at least one ride, time of the at least one ride, speed data during the at least one ride, and acceleration data during the at least one ride.

16. The method of claim 15, wherein, based on the operational data, a manager or owner of the taxi fleet may receive a refund or credit as a function of operational data indicating safe operation of the at least one taxi.

17. The method of claim 11, wherein the operational data include video data recorded by a mobile digital video recorder during the at least one ride, the mobile digital video recorder being installed in the at least one taxi and communicatively coupled to the at least one driver terminal.

18. The method of claim 11, further comprising displaying, by the at least one driver terminal and via at least one external display communicatively coupled to the at least one driver terminal, the video content being selected based on the geographical location.

19. The method of claim 11, further comprising:
analyzing, by the at least one customer module, the operational data to receive a history of at least one taxi driver, the history including at least a speeding event, an aggressive acceleration event, and a hard-braking event;
calculating, by the at least one customer module and based on the history, a score of the at least one taxi driver; and
estimating, by the at least one customer module and based on the score, at least a coverage rate.

20. The method of claim 11, further comprising:
generating, by the at least one customer module and based on operational data, a report concerning productivity of at least one taxi driver and a trip list of the at least one taxi driver, the trip list being compliant with a regulatory requirement.

21. A non-transitory computer-readable storage medium having embodied thereon instructions, which when executed by at least one processor, perform steps of a method, the method comprising:
collecting, by at least one driver terminal installed in at least one taxi, operational data associated with the at least one taxi;
receiving, by at least one data server module for execution on at least one data server communicatively coupled to the at least one driver terminal, the operational data from the at least one driver terminal;
storing and providing, by the at least one data server module, an authorized access to the operational data;
receiving, by at least one customer module for execution on at least one computing device communicatively coupled to the at least one data server, the operational data from the at least one data server;
tracking, by the at least one customer module and based on the operational data, at least a geographical location and occupancy of the at least one taxi; and
dispatching, by at least one customer module and based at least on the geographical location and occupancy, the at least one taxi.
